(19) United States
(12) Patent Application Publication
(10) Pub. No.: US 2012/0038825 A1
(43) Pub. Date: Feb. 16, 2012

(54) Circuits systems & method for computing over a wireless communication architecture

(76) Inventor: Uri Kanonich, Herzlia (IL)

(21) Appl. No.: 13/137,053

(22) Filed: Jul. 18, 2011

Related U.S. Application Data
(60) Provisional application No. 61/344,528, filed on Aug. 16, 2010.

(51) Int. Cl. H04N 5/04

(52) U.S. Cl. 348/500; 348/E05.009

(57) ABSTRACT

A display and input appliance may include one or more wireless communication circuits for wirelessly communicating with a functionally associated processing core or engine. The core may include one or more processors adapted to execute an application and to communicate visual output of the application to the appliance through a wireless communication link established between the appliance's communication circuits and one or more wireless communication circuits associated with the core. Communication may be bidirectional—for example: (1) the core may transmit video and audio streams to the appliance, and (2) the appliance may transmit detected user inputs (e.g. touch, accelerometer input, gyroscope input, GPS, etc.) to the core.

### CROSS REFERENCE

The present application claims the benefit of U.S. Provisional Application 61/344,528 filed Aug. 16, 2010, the disclosure of which is incorporated herein by reference.

### FIELD OF THE INVENTION

Some embodiments relate generally to the field of communication and, more particularly, to circuits systems & methods, for computing over a wireless communication architecture.

### BACKGROUND

Wireless communication has rapidly evolved over the past decades. Even today, when high performance and high bandwidth wireless communication equipment is made available, there is demand for even higher performance at higher data rates, which may be required by more demanding applications.

Video signals may be generated or received by various mobile computing or communications devices, for example, a laptop computer, a netbook, a tablet computer, a smart phone, a game console, an e-book reader, or any other suitable mobile computing or communications device. In many devices, for example, video signals are generated by the device to view on an integral viewing screen, store or transmit to a functionally associated device. Video signals may be received from a functionally associated device, an internal or external memory, a data server, a streaming application, a removable media storage device or any other suitable media storage.

In many cases, the integral viewing screen may be too small and/or may be of poor quality for certain applications (e.g. high definition movie viewing). Thus, wireless transmission of the video signals to a larger screen is preferred.

WHDI—Wireless Home Digital Interface is a standard for wireless high-definition video connectivity between a video source and video sink (e.g. display). It provides a high-quality, uncompressed wireless link which can support delivery of equivalent video data rates of up to 3 Gbit/s (including uncompressed 1080p and stereoscopic 3-D) in a 40 MHz channel within the 5 GHz unlicensed band. Equivalent video data rates of up to 1.5 Gbit/s (including uncompressed 1080i and 720p) can be delivered on a single 20 MHz channel in the 5 GHz unlicensed band, conforming to worldwide 5 GHz spectrum regulations. Range is beyond 100 feet (30 m), through walls, and latency is less than one millisecond.

There have been considerable advancements in the field of computing which recently produced computing products such as the tablet, tablet PC and the like. A tablet PC provides for a very rich and interactive interface experience with relatively large displays and touch-screen inputs. Nevertheless, due to their relatively small size and associated cost constraints, tablet PCs are inherently limited in processing capacity and energy storage capacity.

Both desktop computers and even mobile phones have continuously growing processing power.

There have been considerable advancements in the field of wireless communication which have resulted in communication circuits suitable for transmission of high definition video with substantially no latency.

There is a need in the field of computing for providing a computing/interface device having usability characteristics of a tablet PC with augmented processing power.

### SUMMARY OF THE INVENTION

The present invention includes circuits systems & methods, for computing over a wireless communication architecture. According to some embodiments there is provided a display and input appliance (e.g. tablet shaped device including a flat screen display with touch input functionality), which appliance (hereinafter referred to as “appliance”) may include one or more wireless communication circuits for wirelessly communicating with a functionally associated processing core or engine (hereinafter referred to as a “core”). The core may include one or more processors adapted to execute a (e.g. computationally intensive) application and to communicate visual output of the application to the appliance through a wireless communication link established between the appliance's communication circuits and one or more wireless communication circuits associated with the core. According to further embodiments of the present invention, communication may be bidirectional—for example: (1) the core may transmit video and audio streams (e.g. downlink) to the appliance, and (2) the appliance may transmit detected user inputs (e.g. touch, accelerometer input, gyroscope input, GPS, etc.) to the core (e.g. uplink).

According to some embodiments of the present invention, the wireless communication link (e.g. the downlink and/or the uplink) may be at least partially WHDI compliant. The communication link may be at least partially compliant with Wi-Fi direct, Wi-Fi display, or any other suitable wireless transmission protocol.

According to some embodiments of the present invention, an uplink transmission of detected user inputs may be synchronous with a downlink video and audio stream transmission. Detected user inputs may be linked and/or synchronized with one or more downlink video and audio stream transmission frames. According to some embodiments of the present invention, detected user inputs may be transmitted in a dedicated time slot in between two downlink video and audio stream transmission frames. According to further embodiments of the present invention, the uplink may be transmitted along the same carrier frequency as the downlink. According to some embodiments of the present invention, the uplink transmission of detected user inputs may be a dedicated uplink and may be maintained at a substantially different carrier frequency than the downlink carrier frequency.

According to some embodiments of the present invention, visual output of an executed application may be sent from the core to the appliance without an additional control definition. According to further embodiments of the present invention, detected user inputs may be conditioned, filtered and/or aggregated and transmitted to the core as is (i.e. without control definition interpretation and/or conversion).

According to some embodiments of the present invention, visual output of an executed application may be sent from the core to the appliance with one or more additional control definitions. According to further embodiments of the present invention, detected user inputs may be conditioned, filtered and/or characterized in view of the received control definitions. The characterized user inputs may be transmitted to the core.

According to some embodiments of the present invention, control definitions may define a detected user input as one of a set of predetermined actions and/or gestures related to a corresponding visual output frame (or set of frames). A predetermined action and/or gesture may be a tap, double tap, hold, drag, flick, pinch, select, flip, shake, rotate, move or any other gesture relating to a corresponding visual frame. A control definition may include a screen location or set of screen coordinates wherein a gesture may be registered relative to a specific location within the corresponding frame. According to further embodiments of the present invention, the core may activate and/or deactivate one or more control definitions based on visual content of the visual output frame.

According to some embodiments of the present invention, the appliance may include some programmable data processing circuitry. For a given application, the core may upload to the appliance executable code for processing and transmitting back to the core user inputs detected during the display of the given application video output.

According to some embodiments of the present invention, the core may also include user input sensors (e.g. accelerometers, gyroscopes, etc.) and as part of the execution of some applications may provide both processing and user input detection functionality.

According to further embodiments, two or more Cores, each running corresponding applications, may communicate with one another over a data link (e.g. TCP/IP) so as to provide collaborative computing (e.g. gaming) functionality to respective Appliances connected to each of the two or more Cores.

According to some of the embodiments described above, two or more users may collaboratively play a video game running on a single or multiple Cores and displayed on either one or more appliance devices such as tablet.

According to some embodiments described above, a user may upload or stream multimedia content from the Internet to a core and view the content on a functionally associated appliance. According to further embodiments of the present invention, the user may control the core through the appliance. For example, the user may initiate the download and/or streaming to the core by providing instructions to the core through the appliance.

According to some embodiments of the present invention, a video stream may be composed of sequential video frames, and each video frame may be composed of one or more video blocks including one or more sets of pixels. Prior to transmission of the data associated with a video block, the video block data may be transformed into a set of transform (e.g. frequency) coefficients using a spatial to frequency transform such as a two dimensional discrete cosine transform (DCT). According to some embodiments of the present invention, only a portion or subset of the coefficients of a given video block may be transmitted. Selection of the subset of transform coefficients to be transmitted may be based on a characteristic of the video block. According to further embodiments of the present invention, only a portion or subset of coefficients chosen for transmission may be calculated and transmitted.

According to further embodiments of the present invention, a first portion or subset of the coefficients may be transmitted using a first RF data link and a second portion or subset of the coefficients may be transmitted using a second RF link. One of the RF link may be more secure and/or reliable than the other RF link (e.g. with forward error correction and/or acknowledgement receipts). One set of coefficients may include more spatial information than another set of coefficients.

According to some embodiments of the present invention, when a given video block is determined to be static, frequency coefficients not previously transmitted for a corresponding block may be transmitted. An indicator indicating that this block is static may be transmitted along with the selected coefficients. An image reconstruction module (e.g. decoder and graphics circuit) on the receiver side (e.g. video sink) may receive the indicator and in response may keep a previously generated video block image and may use the received coefficients to augment or enhance the previously generated video block image. The coefficient set selected for a video block designated as static may also include coefficients previously transmitted for a corresponding block from the previous frame. These retransmitted coefficients, which were transmitted as part of the previous frame, may be used by the reconstruction module to enhance the displayed video image by averaging corresponding coefficient values.

According to some embodiments of the present invention, there may be proportionality between the subset of coefficients selected and the security and reliability of the transmission link (e.g. optional forward error correction and/or acknowledgement receipts). According to some embodiments of the present invention, the security and reliability may be based on the strength of the transmission link and/or the type of transmitter used from a plurality of available transmitters. According to some embodiments of the present invention, an RF link with low security and reliability may transmit block transform coefficient data along unreliable bit streams which may not include data link protocols including data frames and/or flow/error control. According to further embodiments of the present invention, a secure and reliable RF link may include data link protocols including the framing of coefficient data and/or flow/error control. According to some embodiments of the present invention, acknowledgments, negative acknowledgements, error detection and/or correction, and checksums may be implemented as features of a secure and reliable RF link.

According to further embodiments of the present invention, video signals may be transmitted using transmission symbols comprised of video data frame coefficients. According to further embodiments of the present invention, low spatial frequency coefficients (i.e. DC coefficients, and/or near DC coefficients) may be represented in a coarse, (i.e. digital) manner. According to further embodiments of the present invention, the low spatial frequency coefficients may be represented as one or more of a plurality of constellation points of a symbol by performing a quantization on their values and mapping them. Coarse data transmission may include additional data values and/or vectors relating to a subset of associated relatively higher frequency coefficients to be transmitted within a separate transmission frame.

According to some embodiments of the present invention, relatively higher frequency coefficients and the quantization errors of the DC and the near DC components may be mapped as fine-constellation points thus providing the fine granularity (i.e. analog-like) values that at an extreme fineness provides for a continuous representation of these values. Further details with regard to methods and systems of uncompressed, wireless transmission of video are described in U.S. patent application Ser. No. 11/551,641 which application is hereby incorporated by reference in its entirety.

According to some embodiments of the present invention, frequency coefficient based transmission symbols may be transmitted using a quadrature amplitude modulation (QAM) based transmitter, an orthogonal frequency-division multiplexing (OFDM) based transmitter, or any other transmitter adapted to transmit data using transmission symbols. According to further embodiments of the present invention, transmission symbol processing may be performed by an integral DSP or by a fast Fourier transformer (FFT) co-processor.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a system level diagram of an appliance core arrangement according to some embodiments of the present invention;

FIG. 2A is a functional block diagram of an exemplary appliance/core arrangement, according to some embodiments of the present invention;

FIG. 2B is a functional block diagram of an exemplary appliance/core arrangement, according to some embodiments of the present invention;

FIG. 2C is a functional block diagram of an exemplary appliance/core arrangement, according to some embodiments of the present invention;

FIG. 3A is a functional block diagram of two appliances interacting with each other via one core, according to some embodiments of the present invention;

FIG. 3B is a functional block diagram of two appliances and two cores interacting, according to some embodiments of the present invention;

FIG. 4 is a functional block diagram of two appliances interacting with each other via one core, according to some embodiments of the present invention;

FIG. 5A is a schematic diagram of video transmission frames in which each frame has a video data portion, a horizontal blanking interval (HBI) portion and a vertical blanking interval (VBI) portion (prior art); and

FIG. 5B is a schematic diagram showing a transmission frame according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

It should be understood that some embodiments may be used in a variety of applications. Although embodiments of the invention are not limited in this respect, one or more of the methods, devices and/or systems disclosed herein may be used in many applications, e.g., civil applications, military applications, medical applications, commercial applications, or any other suitable application. In some demonstrative embodiments the methods, devices and/or systems disclosed herein may be used in the field of consumer electronics, for example, as part of any suitable television, video Accessories, Digital-Versatile-Disc (DVD), multimedia projectors, Audio and/or Video (A/V) receivers/transmitters, gaming consoles, video cameras, video recorders, portable media players, cell phones, mobile devices, and/or automobile A/V accessories. In some demonstrative embodiments the methods, devices and/or systems disclosed herein may be used in the field of Personal Computers (PC), for example, as part of any suitable desktop PC, notebook PC, monitor, and/or PC accessories. In some demonstrative embodiments the methods, devices and/or systems disclosed herein may be used in the field of professional A/V, for example, as part of any suitable camera, video camera, and/or A/V accessories. In some demonstrative embodiments the methods, devices and/or systems disclosed herein may be used in the medical field, for example, as part of any suitable endoscopy device and/or system, medical video monitor, and/or medical accessories. In some demonstrative embodiments the methods, devices and/or systems disclosed herein may be used in the field of security and/or surveillance, for example, as part of any suitable security camera, and/or surveillance equipment. In some demonstrative embodiments the methods, devices and/or systems disclosed herein may be used in the fields of military, defense, digital signage, commercial displays, retail accessories, and/or any other suitable field or application.

Although embodiments of the invention are not limited in this respect, one or more of the methods, devices and/or systems disclosed herein may be used to wirelessly transmit video signals, for example, High-Definition-Television (HDTV) signals, between at least one video source and at least one video destination. In other embodiments, the methods, devices and/or systems disclosed herein may be used to transmit, in addition to or instead of the video signals, any other suitable signals, for example, any suitable multimedia signals, e.g., audio signals, between any suitable multimedia source and/or destination.

Although some demonstrative embodiments are described herein with relation to wireless communication including video information, some embodiments may be implemented to perform wireless communication of any other suitable information, for example, multimedia information, e.g., audio information, in addition to or instead of the video information. Some embodiments may include, for example, a method, device and/or system of performing wireless communication of A/V information, e.g., including audio and/or video information. Accordingly, one or more of the devices, systems and/or methods described herein with relation to video information may be adapted to perform wireless communication of A/V information.

Some demonstrative embodiments may be implemented to communicate wireless-video signals over a wireless-video communication link, as well as Wireless-Local-Area-Network (WLAN) signals over a WLAN link. Such implementation may allow a user, for example, to play a movie, e.g., on a laptop computer, and to wirelessly transmit video signals corresponding to the movie to a video destination, e.g., a screen, while maintaining a WLAN connection, e.g., with the Internet and/or one or more other devices connected to a WLAN network. In one example, video information corresponding to the movie may be received over the WLAN network, e.g., from the Internet.

According to some embodiments of the present invention, there may include a system for computing over a wireless architecture. The system may comprise a processing core (“core”) comprising: (a) a processor adapted to execute a software application; and (b) a source-side transceiver module adapted to transmit along a wireless communication downlink a visual output signal corresponding to a visual output of the application execution. The system may further comprise a display and input appliance (“DIA”) comprising: (a) a sink-side transceiver module adapted to receive the visual output signal; (b) a display adapted to render the received visual output signal; (c) one or more user input sensors adapted to sense and convert user input into user input signals; and (d) user input signal processing logic adapted to condition one or more user input signals for synchronous uplink transmission to the core, wherein the transmission is synchronized with the visual output signal.

According to some embodiments of the present invention, the wireless communication downlink may be composed of one or more transmission frames. According to further embodiments of the present invention, a downlink transmission frame may include one or more complete video frames. According to further embodiments of the present invention, the downlink transmission frame may be a WHDI, Wi-Fi direct or Wi-Fi display transmission frame.

According to some embodiments of the present invention, the system may comprise an uplink transmitter adapted to perform synchronous uplink transmission of conditioned user input signals during a fixed time slot in between downlink transmission frames. According to further embodiments of the present invention, the uplink transmitter may comprise a transmitting unit further adapted to transmit at substantially the same carrier frequency as the wireless communication downlink.

According to some embodiments of the present invention, the system may comprise an uplink transmitter adapted to perform synchronous uplink transmission of conditioned user input signals along a dedicated uplink maintained at a different carrier frequency than the wireless communication downlink.

According to some embodiments of the present invention, the wireless communication downlink may be composed of Wi-Fi packets including a video frame. According to further embodiments of the present invention, the system may further comprise an uplink transmitter adapted to perform synchronous uplink transmission of conditioned user input signals along a dedicated uplink maintained at a different carrier frequency than the wireless communication downlink. According to further embodiments of the present invention, the dedicated uplink may be a point-to-point uplink.

According to some embodiments of the present invention, the wireless communication uplink may be composed of one or more transmission frames. According to further embodiments of the present invention, the uplink conditioned user input signals may be based on sampled sensor outputs. According to some embodiments of the present invention, the uplink conditioned user input signals may be based on an aggregate of multiple sensor outputs.

According to some embodiments of the present invention, the uplink user input signals may be conditioned based on control definitions received with the visual output signal. According to further embodiments of the present invention, conditioned may include a function selected from the group consisting of: filtered, characterized, vectorized, and quantified.

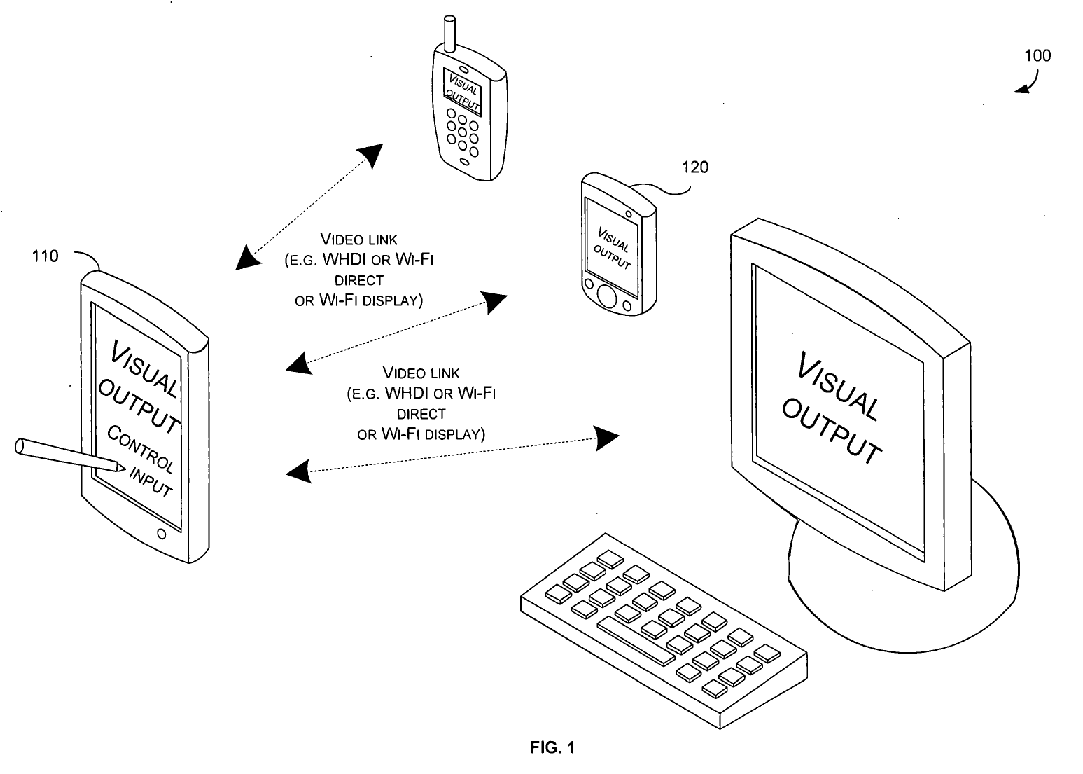

Now turning to FIG. 1, there is shown a system level diagram of an appliance/core arrangement (100), according to some embodiments of the present invention.

According to some embodiments of the present invention, a display and input appliance (i.e. appliance) may be a tablet shaped device including a flat screen display with touch-screen input functionality (110). According to further embodiments of the present invention, a processing core or engine (i.e. core) may be a computing and or processing device (e.g. smart phone 120). According to further embodiments of the present invention, both an appliance (110) and a core (120) may include one or more wireless communication circuits for direct communication over a video link. Direct communication may be at least partially compatible with WHDI, Wi-Fi direct or Wi-Fi display.

According to some embodiments of the present invention, the core (120) may execute an application and generate a visual output. The visual output may be transmitted to the appliance (110). According to further embodiments of the present invention, the appliance (110) may be detect user input (e.g. via the touch-screen input). The user input may be transmitted to the core.

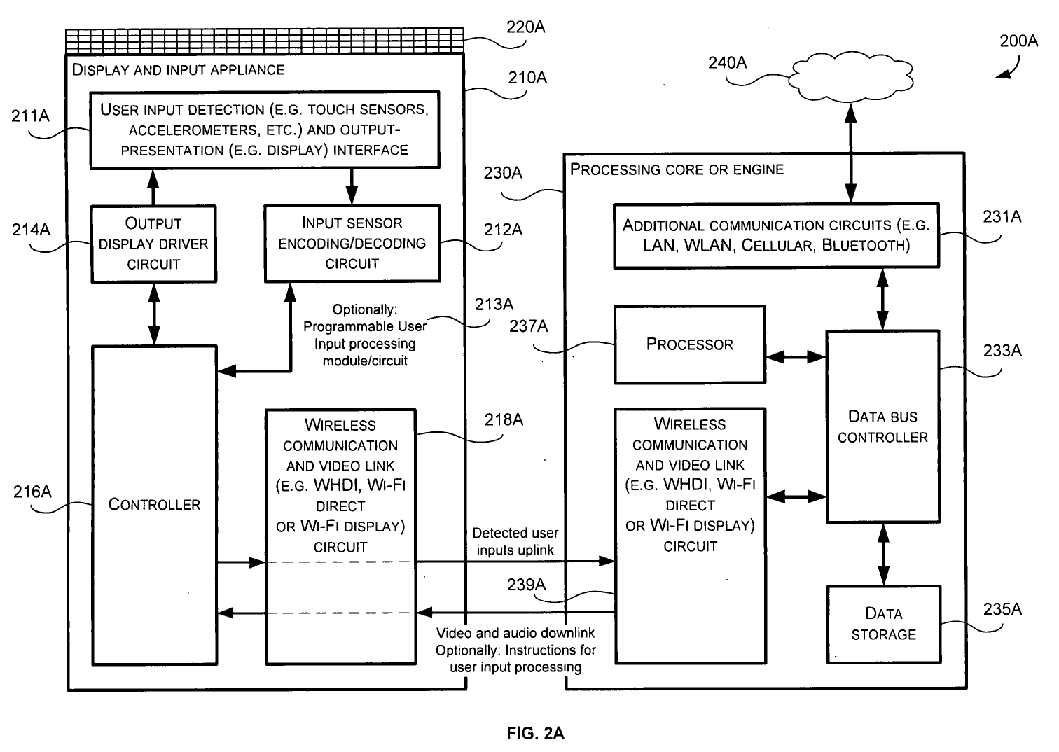

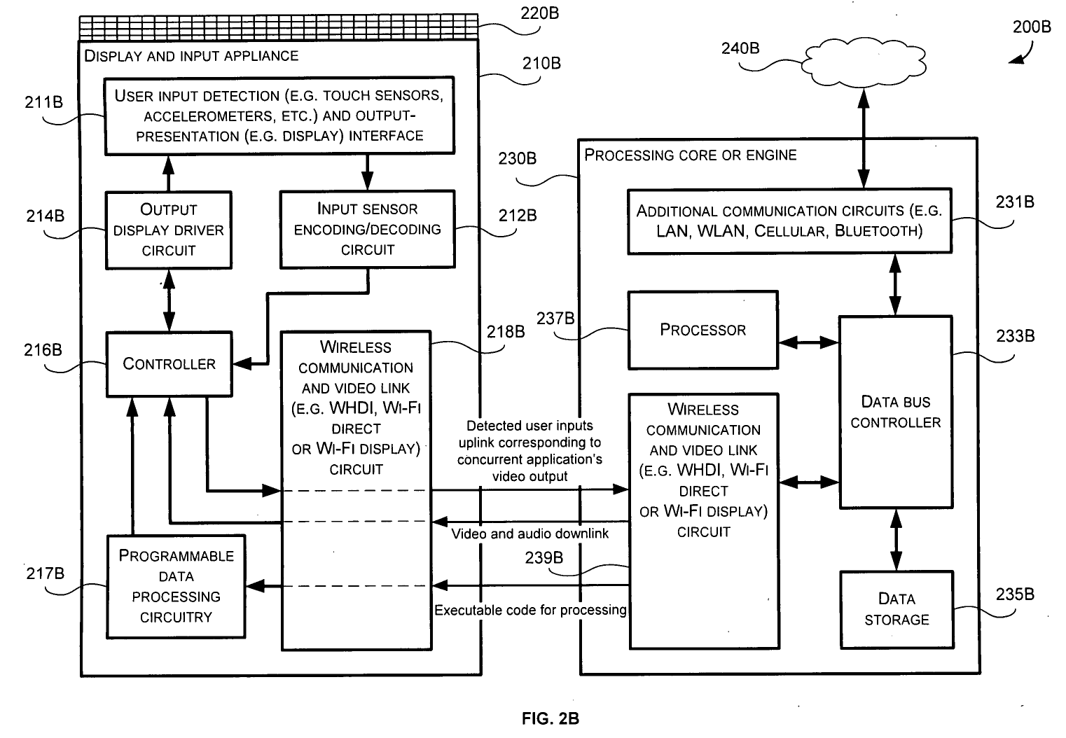

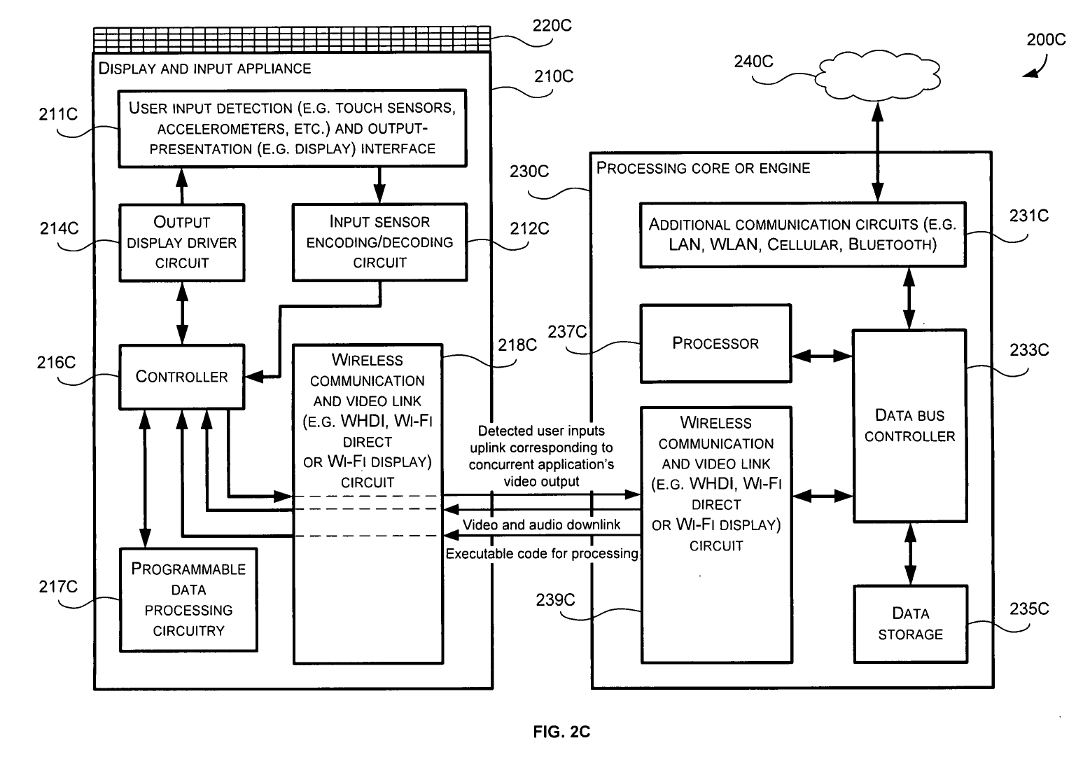

Now turning to FIG. 2A, there is shown a functional block diagram of an exemplary appliance/core arrangement (200A), according to some embodiments of the present invention.

According to some embodiments of the present invention, a display and input appliance (i.e. appliance—210A) may include a flat screen display with touch-screen input functionality (220A). The appliance (210A) may include a user input detection and output presentation interface (211A) to detect user inputs (e.g. from touch sensors, accelerometers, gyroscopes, etc.) and output video to the display. According to further embodiments of the present invention, the appliance (210A) may contain an input sensor encoding/decoding circuit to process user inputs for a functionally associated or otherwise integral controller (216A). There may be a programmable user input processing module/circuit (213A) that may process user inputs based on an executable program code. According to further embodiments of the present invention, processed user input may be sent from the controller (216A) to a wireless communication and video link (e.g. WHDI, Wi-Fi direct or Wi-Fi display) circuit (218A) for uplink transmission to a functionally associated core.

According to some embodiments of the present invention, the wireless communication and video link (e.g. WHDI, Wi-Fi direct or Wi-Fi display) circuit (218A) may receive a video and audio downlink from a functionally associated core. Instructions for user input processing may also be received. According to further embodiments of the present invention, the controller (216A) may send the video and audio data to a functionally associated or otherwise integral output display driver circuit (214A) to prepare the data for the output presentation interface (211A). According to further embodiments of the present invention, received instructions for user input processing may be sent to the programmable user input processing module/circuit (213A) to process user inputs based on the received instructions.

According to some embodiments of the present invention, a processing core or engine (i.e. core—230A) may contain a processor (237A) for executing an application received from a functionally associated data bus controller (233A). The data bus controller (233A) may receive application data from data storage (235A) or from additional communication circuits (231A). The communication circuits (231A) may communicate using LAN, WAN, cellular, Bluetooth, or any other communication protocol and may receive data from the Internet or any cloud-based or otherwise network-based data source (240A).

According to some embodiments of the present invention, the data bus controller (233A) may receive visual output corresponding to an executed application from the processor (237A). The received visual output may be sent to a functionally associated or otherwise integral wireless communication and video link (e.g. WHDI, Wi-Fi direct or Wi-Fi display) circuit (239A) for downlink transmission to a functionally associated appliance (220A).

According to some embodiments of the present invention, the wireless communication and video link (e.g. WHDI, Wi-Fi direct or Wi-Fi display) circuit (239A) may receive one or more detected user inputs from the functionally associated appliance (220A). The user inputs may be sent to the processor (237A) via the data bus controller (233A) for application execution in view of the user inputs. According to further embodiments of the present invention, the core (230A) may send application-specific instructions for user input processing to the appliance (220A).

Now turning to FIG. 2B, there is shown a functional block diagram of an exemplary appliance/core arrangement (200B), according to some embodiments of the present invention.

It is understood that elements 230A, 231A, 233A, 235A, 237A, 239A and 240A of FIG. 2A are substantially the same as elements 230B, 231B, 233B, 235B, 237B, 239B and 240B of FIG. 2B respectively.

According to some embodiments of the present invention, a display and input appliance (i.e. appliance—210B) may include a flat screen display with touch-screen input functionality (220B). The appliance (210B) may include a user input detection and output presentation interface (211B) to detect user inputs (e.g. from touch sensors, accelerometers, gyroscopes, etc.) and output video to the display. According to further embodiments of the present invention, the appliance (210B) may contain an input sensor encoding/decoding circuit to process user inputs for a functionally associated or otherwise integral controller (216B). According to further embodiments of the present invention, processed user input may be sent from the controller (216B) to a wireless communication and video link (e.g. WHDI, Wi-Fi direct or Wi-Fi display) circuit (218B) for uplink transmission to a functionally associated core.

According to some embodiments of the present invention, the wireless communication and video link (e.g. WHDI, Wi-Fi direct or Wi-Fi display) circuit (218B) may receive a video and audio downlink from a functionally associated core. Executable code for user input processing may also be received. According to further embodiments of the present invention, the controller (216B) may send the video and audio data to a functionally associated or otherwise integral output display driver circuit (214B) to prepare the data for the output presentation interface (211B). According to further embodiments of the present invention, received instructions for user input processing may be sent to a programmable data processing circuitry (217B) for processing. Processed instructions for user input may be sent to the controller (216B) to process user inputs based on the processed instructions.

Now turning to FIG. 2C, there is shown a functional block diagram of an exemplary appliance/core arrangement (200C), according to some embodiments of the present invention.

It is understood that elements 230A, 231A, 233A, 235A, 237A, 239A and 240A of FIG. 2A are substantially the same as elements 230C, 231C, 233C, 235C, 237C, 239C and 240C of FIG. 2C respectively.

According to some embodiments of the present invention, a display and input appliance (i.e. appliance—210C) may include a flat screen display with touch-screen input functionality (220C). The appliance (210C) may include a user input detection and output presentation interface (211C) to detect user inputs (e.g. from touch sensors, accelerometers, gyroscopes, etc.) and output video to the display. According to further embodiments of the present invention, the appliance (210C) may contain an input sensor encoding/decoding circuit to process user inputs for a functionally associated or otherwise integral controller (216C). According to further embodiments of the present invention, processed user input may be sent from the controller (216C) to a wireless communication and video link (e.g. WHDI, Wi-Fi direct or Wi-Fi display) circuit (218C) for uplink transmission to a functionally associated core.

According to some embodiments of the present invention, the wireless communication and video link (e.g. WHDI, Wi-Fi direct or Wi-Fi display) circuit (218C) may receive a video and audio downlink from a functionally associated core. Executable code for user input processing may also be received. According to further embodiments of the present invention, the controller (216C) may send the video and audio data to a functionally associated or otherwise integral output display driver circuit (214C) to prepare the data for the output presentation interface (211C). According to further embodiments of the present invention, received instructions for user input processing may be sent by the controller (216C) to a programmable data processing circuitry (217C) for processing. Processed instructions for user input may be sent back to the controller (216C) to process user inputs based on the processed instructions.

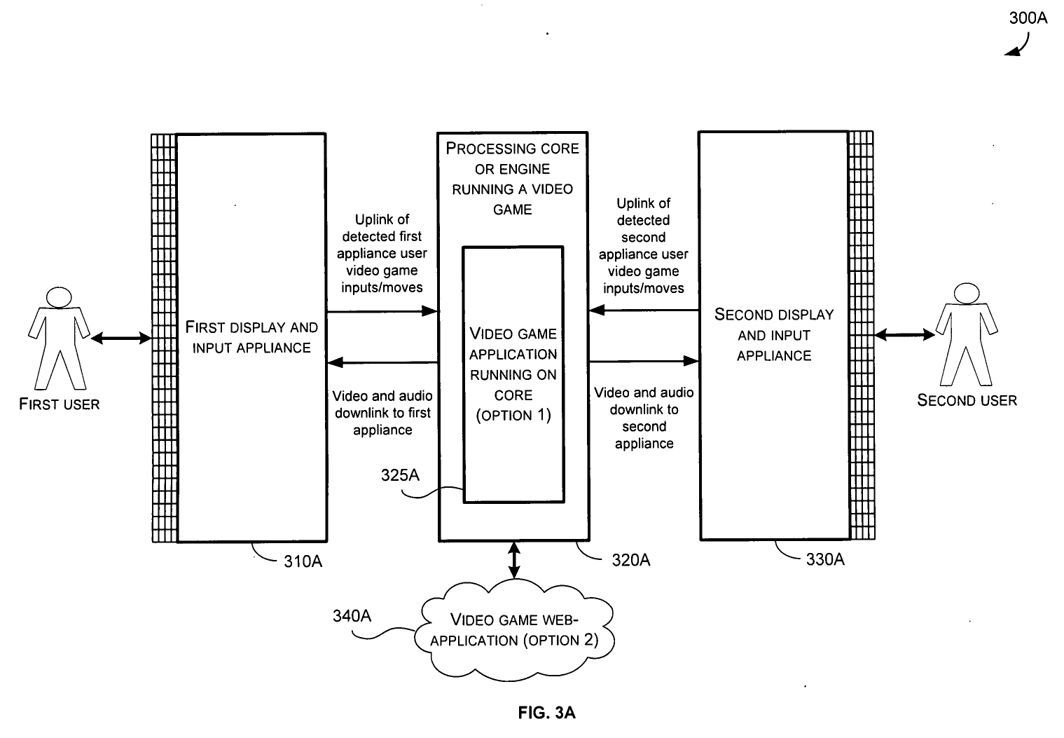

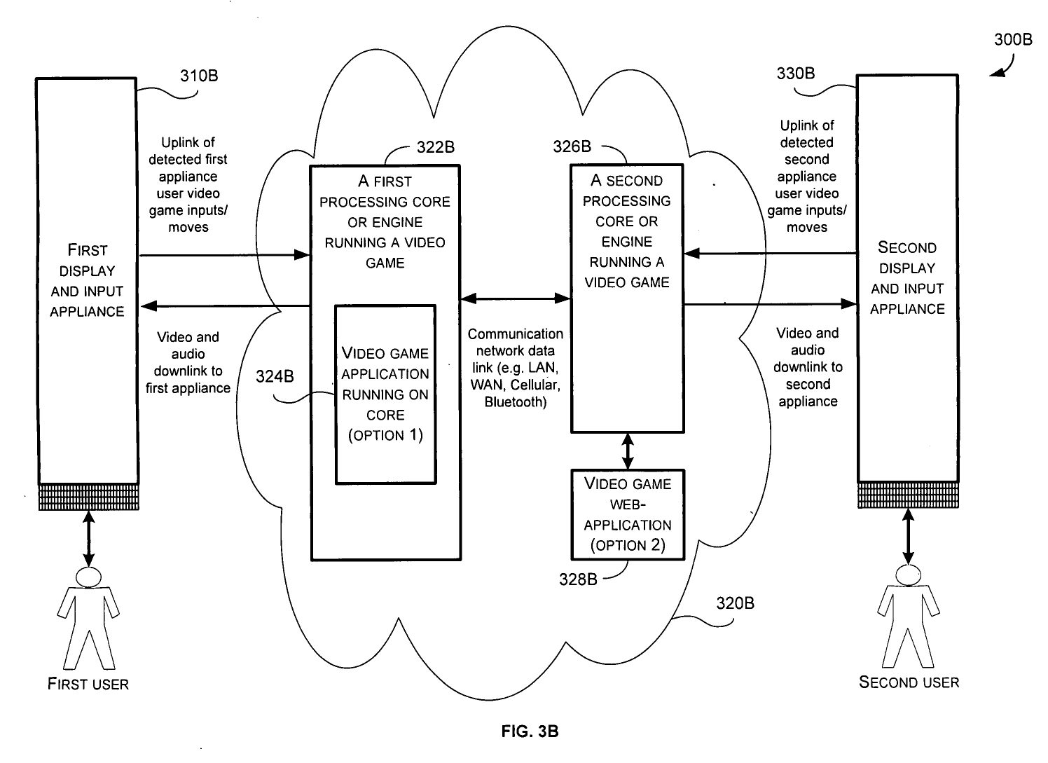

Now turning to FIG. 3A, there is shown a functional block diagram of two appliances interacting with each other via one core (300A), according to some embodiments of the present invention.

According to some of the embodiments described above, two or more users may collaboratively play a video game running on a single or multiple Cores and displayed on either one or more appliance devices such as tablet.

According to some embodiments of the present invention, a first display and input appliance (appliance 310A) may receive user inputs from a first user. A second display and input appliance (appliance 330A) may receive user inputs from a second user. According to further embodiments of the present invention, a processing core or engine running a video game (core 320A) may maintain simultaneous communication sessions with appliance 310A and appliance 330A. A communication session may include a video and audio downlink (i.e. core to appliance) and a detected user video game inputs/moves uplink (i.e. appliance to core).

According to some embodiments of the present invention, a video game application may be running from a local memory and/or storage device (325A). According to further embodiments of the present invention, the core (320A) may execute a video game web application (340A).

Now turning to FIG. 3B, there is shown a functional block diagram of two appliances and two cores interacting (300B), according to some embodiments of the present invention.

According to some embodiments of the present invention, a first display and input appliance (appliance 310B) may receive user inputs from a first user. A second display and input appliance (appliance 330B) may receive user inputs from a second user. According to further embodiments of the present invention, a first processing core or engine running a video game (core 322B) may maintain a communication session with appliance 310B. A communication session may include a video and audio downlink (i.e. core to appliance) and a detected first appliance user video game inputs/moves uplink (i.e. appliance to core). According to further embodiments of the present invention, a second processing core or engine running a video game (core 326B) may maintain a communication session with appliance 330B. A communication session may include a video and audio downlink (i.e. core to appliance) and a detected second appliance user video game inputs/moves uplink (i.e. appliance to core). According to further embodiments of the present invention, two or more Cores may communicate directly with each other (320B) over some communication network data link (e.g. LAN, WAN, cellular, Bluetooth).

According to some embodiments of the present invention, a video game application may be running from a local memory and/or storage device (324B). According to further embodiments of the present invention, a core (326B) may execute a video game web application (328B).

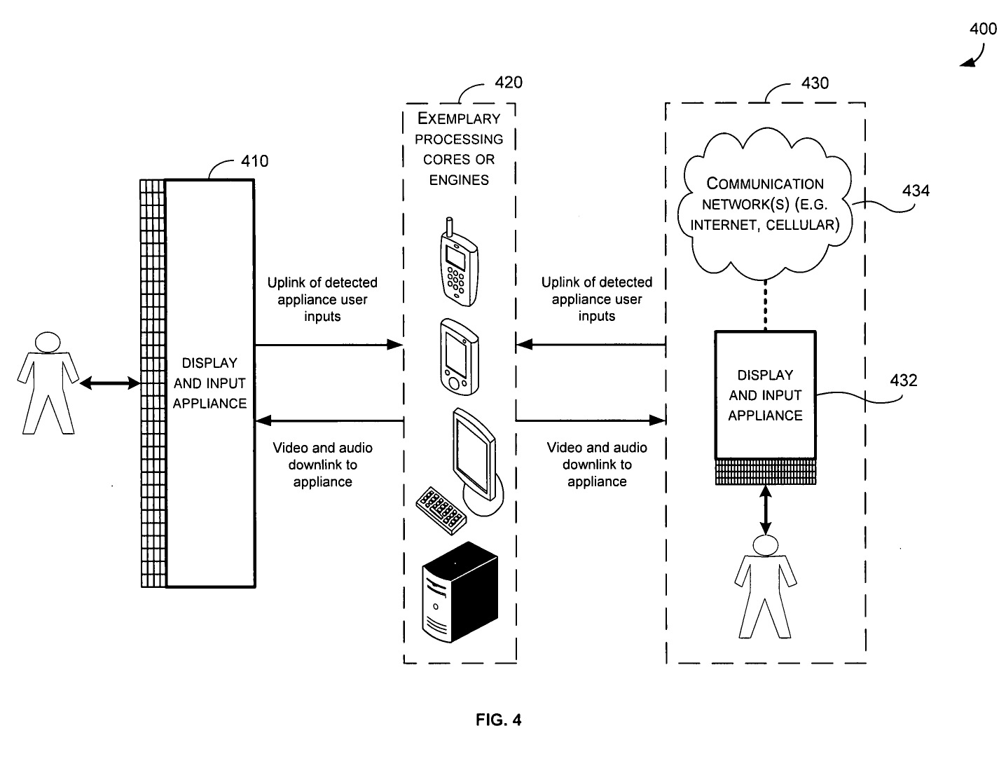

Now turning to FIG. 4, there is shown a functional block diagram of two appliances interacting with each other via one core (400), according to some embodiments of the present invention.

According to some embodiments of the present invention, a user may upload or stream multimedia content from a communication network (434—e.g. the Internet, a cellular network, etc.) to a processing core or engine (core 420) and view the content (430) on a functionally associated appliance (432). According to further embodiments of the present invention, the user may control the core (420) through the appliance (432). For example, the user may initiate the download and/or streaming to the core (420) by providing instructions to the core (420) through the appliance (432).

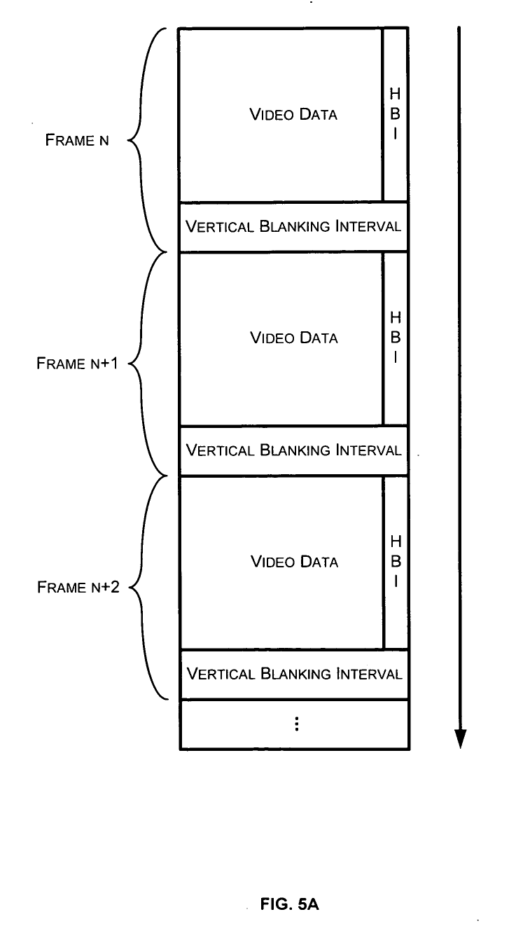

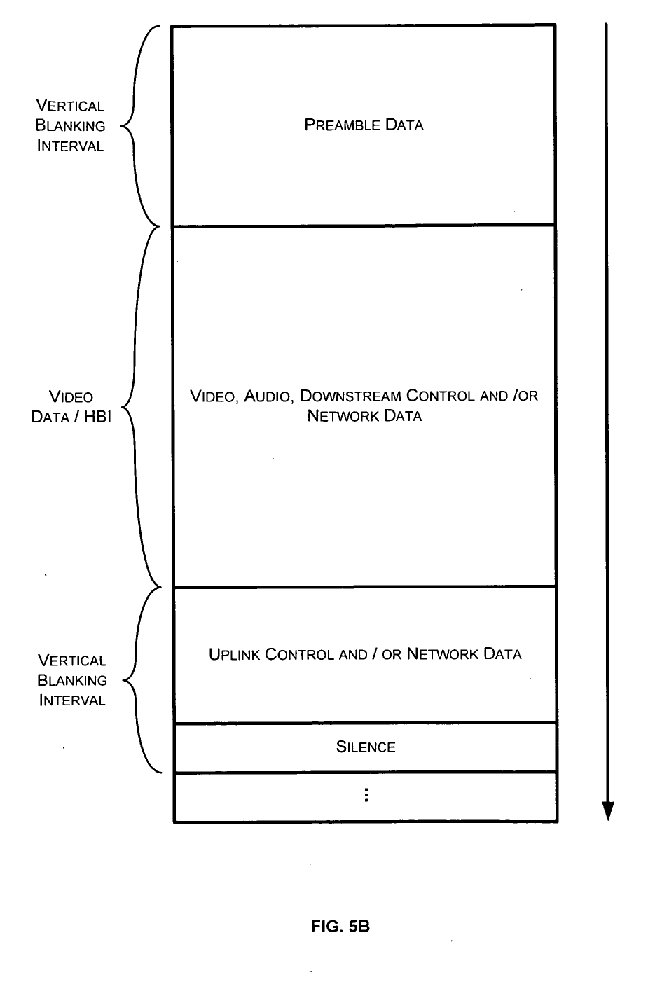

Now turning to FIG. 5A, there is shown a schematic diagram of video transmission frames in which each frame has a video data portion, a horizontal blanking interval (HBI) portion and a vertical blanking interval (VBI) portion (prior art).

Now turning to FIG. 5B, there is shown a schematic diagram showing a transmission frame according to some embodiments of the present invention.

According to some embodiments of the present invention, an initial time slot reserved for a VBI in the prior art may be used to transmit preamble data (e.g. set-up or protocol information). According to further embodiments of the present invention, the video data portion and HBI portion in the prior art may be utilized for a downlink transmission frame. According to further embodiments of the present invention, the downlink transmission frame may include video data, audio data, control data (i.e. user input processing instructions), and/or network data. According to further embodiments of the present invention, the VBI portion in the prior art may be used for transmitting and receiving uplink control (i.e. detected user inputs) and/or network data. According to further embodiments of the present invention, a time slot may be reserved for uplink and downlink silence (i.e. a guard interval).

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A system for computing over a wireless architecture, said system comprising:
a processing core (“core”) comprising: (a) a processor adapted to execute a software application; and (b) a source-side transceiver module adapted to transmit along a wireless communication downlink a visual output signal corresponding to a visual output of the application execution; and
a display and input appliance (“DIA”) comprising: (a) a sink-side transceiver module adapted to receive the visual output signal; (b) a display adapted to render the received visual output signal; (c) one or more user input sensors adapted to sense and convert user input into user input signals; and (d) user input signal processing logic adapted to condition one or more user input signals for synchronous uplink transmission to said core, wherein the transmission is synchronized with the visual output signal.

2. The system according to claim 1, wherein the wireless communication downlink is composed of one or more transmission frames.

3. The system according to claim 2, wherein a downlink transmission frame includes one or more complete video frames.

4. The system according to claim 3, wherein the downlink transmission frame is a WHDI transmission frame.

5. The system according to claim 3, wherein the downlink transmission frame is a Wi-Fi direct transmission frame.

6. The system according to claim 3, wherein the downlink transmission frame is a Wi-Fi display transmission frame.

7. The system according to claim 2, further comprising an uplink transmitter adapted to perform synchronous uplink transmission of conditioned user input signals during a fixed time slot in between downlink transmission frames.

8. The system according to claim 7, wherein the uplink transmitter further comprises a transmitting unit adapted to transmit at substantially the same carrier frequency as the wireless communication downlink.

9. The system according to claim 2, further comprising an uplink transmitter adapted to perform synchronous uplink transmission of conditioned user input signals along a dedicated uplink maintained at a different carrier frequency than the wireless communication downlink.

10. The system according to claim 1, wherein the wireless communication downlink is composed of Wi-Fi packets including a video frame.

11. The system according to claim 10, further comprising an uplink transmitter adapted to perform synchronous uplink transmission of conditioned user input signals along a dedicated uplink maintained at a different carrier frequency than the wireless communication downlink.

12. The system according to claim 11, wherein the dedicated uplink is a point-to-point uplink.

13. The system according to claim 1, wherein the wireless communication uplink is composed of one or more transmission frames.

14. The system according to claim 13, wherein the uplink conditioned user input signals are based on sampled sensor outputs.

15. The system according to claim 14, wherein the uplink conditioned user input signals are based on an aggregate of multiple sensor outputs.

16. The system according to claim 1, wherein the uplink user input signals are conditioned based on control definitions received with the visual output signal.

17. The system according to claim 16, wherein conditioned includes a function selected from the group consisting of: filtered, characterized, vectorized, and quantified.
